(19) United States
(12) Patent Application Publication
(10) Pub. No.: US 2010/0121481 A1
(43) Pub. Date: May 13, 2010

(54) AUTOMATED SELF-STORAGE SYSTEM

(76) Inventors: Paul A. Talley, Coral Springs, FL (US); Anthony V. Pugliese, III, Delray Beach, FL (US)

Correspondence Address: BLANK ROME LLP, ONE LOGAN SQUARE, PHILADELPHIA, PA, 19103, US

(21) Appl. No.: 12/690,746

(22) Filed: Jan. 20, 2010

Related U.S. Application Data
(63) Continuation of application No. 11/512,401, filed on Aug. 30, 2006, now abandoned.
(60) Provisional application No. 60/712,679, filed on Aug. 30, 2005.

(51) Int. Cl. B65G 1/137; G06F 7/00

(52) U.S. Cl. 700/215; 700/214

(57) ABSTRACT

An automated self storage facility which stores individual items in movable storage units and/or storage containers which are stored throughout the storage facility. Limited users access to the facility is provided at predesignated locations. The users container is transported between its storage location and the access location by the automated robotic system within the facility to provide efficient handling, storage and retrieval of goods in a storage facility. A central control system maintains a record container location throughout the facility. Upon request the system retrieves a container and delivers it. The containers may be partitioned such that a single container may have multiple compartments. In this case the automated system maintains a record of compartments and appropriately orients the container at the access location upon retrieval.

### RELATED APPLICATIONS

This application is a continuation of U.S. application Ser. No. 11/512,401, filed Aug. 30, 2006, entitled Automated Self-Storage System; which application claims benefit of priority of U.S. Provisional Application No. 60/712,679, filed Aug. 30, 2005. The above-identified related applications are incorporated herein by reference.

### BACKGROUND OF THE INVENTION

The present invention relates to an automated self storage facility which stores individual items in movable storage units and/or storage containers which are stored throughout the storage facility. Limited users access to the facility is provided at predesignated locations. The users container is transported by the system within the facility to the access location when accessed by the user. The system of the present invention provides efficient handling, storage and retrieval of goods in a storage facility.

In a typical self storage facility, each storage unit is provided with its own access door. In order to access a storage unit each unit must face the exterior of the building,or interior passageways and corridors must be provided for interior facing storage units up. Because of the need to access each minute individually, a large portion of the facility is consumed by access passageways. Because users of the facility are transporting goods into and out of the storage units, the corridors and passageways must be sufficiently large to provide convenient access. This again consumes significant amounts of storage facility space. If each of the units must face the exterior of the facility, the facility is often a minute to a single level and therefore takes a significant real estate and requires CD of an additional access roads through and around the facility. Often facilities of this type are there for the series of separate single story buildings and are limited and location because of the need for a large tract of land.

There have been other attempts to reduce the land needed for a storage facility by providing movable storage units and limited access points. For example, U.S. Pat. No. 6,694,217, issued to Bloom, teaches an automated system of storage locker bins which circulate a vertically on an endless conveyor, as does U.S. Pat. No. 5,385,265 to Schlamp. U.S. Pat. No. 5,593,269 issued to Bernard also teaches a vertical conveyor for material handling not for storage bins. A U.S. Pat. No. 5,899,657 to Hodges teaches a horizontal conveyor system for the storage of automobiles and other cargo. U.S. Pat. No. five, 447,407 to Weaver, teaches a combined force of will and vertical conveyor for the storage of large containers. U.S. Pat. No. 5,953,234 to Singer, teaches an automated storage facility for pelletized inventories management systems.

In addition to systems which teach the handling and movement of storage containers or cargo, there are also systems such as taught in U.S. Pat. No. 6,010,064, which teach automated access via a user input system.

### SUMMARY OF THE INVENTION

Specifically, the system comprises a series of storage containers and an associated series of storage bays. Each container is stored in a bay and a central control system maintains a record of which they each container is stored in. Upon a request by a user of the storage facility to access his container, a container handling system retrieves said container and delivers it to a common user access point such as a facility doorway. Upon completion of his access, the user requests the automated self storage system to re-stow his container. The system places the container in any currently open bay and updates its records to maintain the association of that new bay with that container.

The automated system is accessed via a key pad or other electronic interface device. The user enters identifying information for the container desire to be accessed together with a form of authentication. If the authentication is valid for the desired container, the system searches its memory for the location of the requested container, sends the handling system to the associated day and retrieves the container to the user access point. Another entry on the interface device returns the container to an unoccupied bay.

The containers may be partitioned such that a single container may store of goods from more than one user in this case the automated system maintains a record of which user is associated with a particular partitioned area of a container. The system also maintains information regarding the orientation of each of those areas relative to the overall orientation of the container. The system also maintains a record of the orientation of each container in each associated bay so that when a container is delivered to the storage facility doorway for access by the user, it will be oriented correctly to allow the user access to his particular partitioned portion of the container so as to allow access to only the user's own goods.

This idea will automate the self storage industry by the mobilization and racking of the storage containers in a large facility. With the system of the present invention, the user has the ability to access his storage unit at the door of the facility. The user is able to load and unload without the need to enter the facility or to navigate internal corridors and or staircases. The present convention also allows for substantially increased storage area on a substantially reduced at facility footprint. By eliminating the need for inter facility passageways and multiple access to individual units, the system of the presentation allows for reduced facility costs and increased land usage density an allowance for increased facility height while maintaining easy access at ground level.

The system of the present convention provides a key pad and additional access security device at a facility access point. The user of the facility enters a code and provides whatever additional access is required by the facility in order to gain access to an assigned storage unit. The assigned storage unit is retrieved from its storage location within the facility and access is provided to the user at the facility access point. The users storage unit or container, is then robotically retrieved and dropped off in the loading area of. The user is able to load and or unload items for storage in his storage unit. When storage and retrieval of items is completed, the unit is closed and the user instructs the facility to return the storage container to any open storage bay. By returning the storage unit to any open bay, the system is able to manage the retrieval and return of storage units in a more efficient manner as explain more fully below. The system maintains information regarding the location of each storage unit for future retrieval of the storage unit from its new location within the facility.

In operations, a user of the facility leases a space consisting of an entire container or a subdivided portion of the container. The user is given a code or an access card or other means of secure access to his storage unit. The identification and ownership of the storage unit is stored within the system for operating the facility. The units can be all of a single size in exterior to mention for proper interoperation within a single facility or the units can be one of a fixed set of standard of mentioned units For example units may come in full size half size and quarter size whereby one, two or more units may be stored in a single unit bay.

If the storage units are subdivided into internal compartments, each of the internal compartments has a separate access opening. The storage unit is rotated about its central axis in order to present the appropriate opening to the facility access door according to the user assigned internal compartment of the storage unit.

Each of the storage units is configured and mounted to ride on a quarterly system. The units can move in multiple directions both horizontally and vertically throughout the facility into two placed the units in storage base, retrieve the units from storage bays and present the units to the facility access doors. The location of the units is tracked throughout the storage facility both by a computer tracking system which maintains information regarding the location of the storage units which can be verified for use of any of the number of location tracking systems including barcodes, scan tags, passive transponders, infrared tags, RF tags and the like. The system maintains the location of each storage unit so that the mechanism used to retrieve and move the units will know where to retrieve the unit from.

When a user leasing a unit comes to the facility access door and provides the proper authentication, the desired unit is located by the system and the system sends the retrieval mechanism to the appropriate location. If other storage units are stacked between the retrieval passageway and the desired unit those units are first moved out of position so that the desired unit can be accessed. The desired unit is then moved toward the facility access door where the user is waiting. During the process of movement from its storage location to be accessed location, if necessary, the unit is rotated so that the proper access opening will be presented to the facility access door. As the storage unit moves through the facility the tracking system which keeps track of the storage unit moving mechanism as well as any other location verification system tracks its movement through the facility. When access to the storage unit is completed, and the user closes the facility door the storage unit is returned to a storage bay. Because the system tracks the location of storage units throughout the facility, it is not necessary to return to storage unit to its original storage battery. This allows the storage unit moving mechanism to store the unit in the most desirable available space. This space may be the first available space or it may be a particular area of the facility based upon a number of factors discussed below.

The system of the present mentioned as described in greater detail below, has many inventions including the ability to move storage units within a building without human assistance, providing storage compartments of many different sizes to meet the requirements of different users, and allowing for access to a single unit from multiple sides by different users.

The concept and thought is convenient and efficient for public access self storage. A storage facility user will not need to lug all his things into the building up to a floor, in some cases and down long hallways. This is usually the worst thing about self storage facilities. The other concern is security. Is the users property safe and are users safe when negotiating long hallway deep in a building?

The system is comprised of a series of units that very in size for the users needs. Sizes range from 5×5, 5×10, 10×10, 10×15, and 10×20 these units are assembled on a table/pallet that is 10′×20′. Depending on the local demographics and studies a unit mix is determined. When the units are built on the table there are either multiple sizes using increments of 5′ or a single unit on each table, depending on the configuration and unit mix.

When a user come to the storage facility the user parks in a loading area. Depending on the size of the building, access spaces may vary from two to ten spaces. There will be a control access point for each loading area. This device could be a key pad, card reader, or a series of both of other entry security systems or devices. Each user enters an assigned pass code or swipes a pass card or otherwise activates a secure access system. This information is then sent to the facility management system. This system is constantly updating information such as payments, frequency of visits, and habits like when a particular users access a particular unit and the amount of time a user maintains the unit at an access port. The amount of time before a unit is re-stored. This information is processed by the control system and sent to the management system and is uses it to manage the positions of all the units in the building.

After the user enters his pass code the system retrieves the table/palette containing the users unit. If needed the system moves the palette to a turn table that reposition the palette unit for access to your unit, it then moves it to the commanded loading space of the user. Once the unit is delivered to the display area the exterior door of the facility will open revealing the door-less access port to the users unit and the user can then access the assigned storage space. The unit can alternatively also have its own door that is secured by a user lock.

When the user has completed his activity in his unit he enters his code of other security access method for return to the system. At that time the management system will perform a series of safety checks. First it will check for movement within the unit, it may also check for heat or other biological scan and detection methods, once complete it will close the access door, and then it will rescan again for movement and assess the heat element and weight and potentially other biological detection methods. Once that is complete and OK, the system will capture and restore the table. If there is a problem with the safety checks the access door will reopen so the problem can be resolved or inspected by staff and cleared for return to the system.

The configuration of the system, while generally standardized, can he custom designed for each sites requirements. The frame that holds the tables/units is engineered for its geographic regions. It is constructed with a grid of steel columns spaced for the configuration of the units with beams to carry the units for stacking to the desired height. This frame is self supporting and is open throughout. There is bracing, as needed, per design engineering. The building shell and roof may be braced to the frame if needed for lateral support or it can be completely independent, there is an unobstructed rail way through the center of the building. The rail way is depressed in the slab so when it delivers a unit it is at grade level. The crane runs from end to end to retrieve units from any position at any height. This is an automated crane controlled by the management control system. The crane has an operator station for service and emergency operations. Each opening in the frame system has rails on the bottom for the unit to rest on. Depending on the configuration of the facility these openings may be six positions deep (side to side) for maximum efficiency. On the top of the storage positions attached to the beams will be the fire sprinkler system designed for storage.

The units are moved to the isle position for pick up by the crane with a satellite that is attached to the crane. This system is tendered to the crane. If you call for a unit that is six deep in the frame, the management system will tell the crane and it will reposition the units in front of the desired unit. The table/palate that holds the storage units are built on are aluminum. That is the structural requirement to carry the weight set by industry standards for storage. The top of the table will have a slight indentation sloping towards three mid points. This is if a small amount of liquid is spilled in a unit it won't leak below to other units. The units are built on the table with a manufactured steel wall system designed for this application. The wall, system is built to accommodate the doors on both side or end positions and the unit mix calculations as desired. The wall system is braced at the top with cross braces this will keep the unit square and ridged. If the unit flexes or becomes skewed, it will be returned to the loading position and the system will notify the attendant. There is a set of inferred beams that review the unit on the table to ensure that it is straight and square with the table before it is taken to be re-racked. This will ensure that it has not shifted or leaned for improper stacking and won't ram the frame when it is moving down the hoist way.

There are 4 possible sides that will need to be displayed. A turn-table will be used to rotate the unit for proper display to the loading door. With the management system it will identify using the scan tag and the position of that tag from its mounting location in reference to the desired side or end that is being called for. The scan tags cab be visual, RF, IR, proximity, passive responder or any applicable tracking system, There will be scan readers in several locations to keep track of the units as they move through the building.

The management system will be a standard warehouse management system integrated with our storage control system that gives the management system information to perform its task and maintenance necessary for public storage. These commands would be access to the unit, storage history for maintenance, and positioning for placement in frame, average time needed once the unit is displayed for loading or unloading, and weight limits in place for the size of the unit leased. This self storage control system will be merged with the management system to manage the facility.

The display area, which is where the unit is placed for access to the users, is completely enclosed and isolated from the main storage system for safety. This area is built with metal wall system and ceiling and a self operating door between the display area and the storage area. When the unit is being loaded it is also being weighed. This weight is displayed in the loading area and is monitored by the management system. The weight limited is predetermined by the size of space being used on the entire table and is part of the safety system. The interior door is used for two reasons one is to stop the controlled environment in the building from escaping and two for security. In the enclosed display area there are a series of sensors that do checks before it will allow the unit back in the building. These include motion sensors, rate of temperature rise, alignment scanners that check to make sure that the unit was not damaged during loading, and infrared scanner to insure that no one is in the unit and potentially other biologic detectors. If any of these monitors sense a problem it will reopen the exterior door so the problem can be rectified. If every thing is checked and the system is normal it can be overrode by the attendant on duty. The most common reason for non return may temperature in the hottest part of summer. The heat sensors will detect high heat levels that will have to be checked by the attendant and cleared for return.

Motion sensors in the unit can also monitor shifts in loads during transport and/or while the unit is in storage. The detection of a load shift can then be reported to the system control for the action.

The loading area in the storage facility has a front door for access by the users of the facility and a rear door which opens to the storage area of the facility. Only one of the two doors can be open at any one time, to prevent access by the users to the interior of the storage facility both doors remain closed until a storage unit is being moved into position in the access area. The rear door is opened and the storage unit moves through the rear door into the access area at which time the rear door is closed. The front door can then open allowing access by the user to his storage unit while preventing access to other units. Once the front door is closed, the rear door can be opened to allow the storage unit to be moved back into the main portion of the storage facility.

### BRIEF DESCRIPTION OF THE FIGURES

For a better understanding of the nature of the present invention, reference is had to the following figures and detailed description, wherein like elements are accorded like reference numerals, and wherein:

FIG. 1 is a top plan view of an exemplary layout for a storage facility according to one embodiment of the present invention.

FIG. 2 is a block floor plan diagram of an alternative layout for a storage facility according to an embodiment fo the present invention,

FIG. 3 is an end elevation view of the facility illustrated in FIGS. 1 and 2, illustrating four levels of stacked storage containers.

FIGS. 4, 5 and 6 are perspective views of different exemplary storage units of the present invention.

### DETAILED DESCRIPTION OF EXEMPLARY EMBODIMENTS

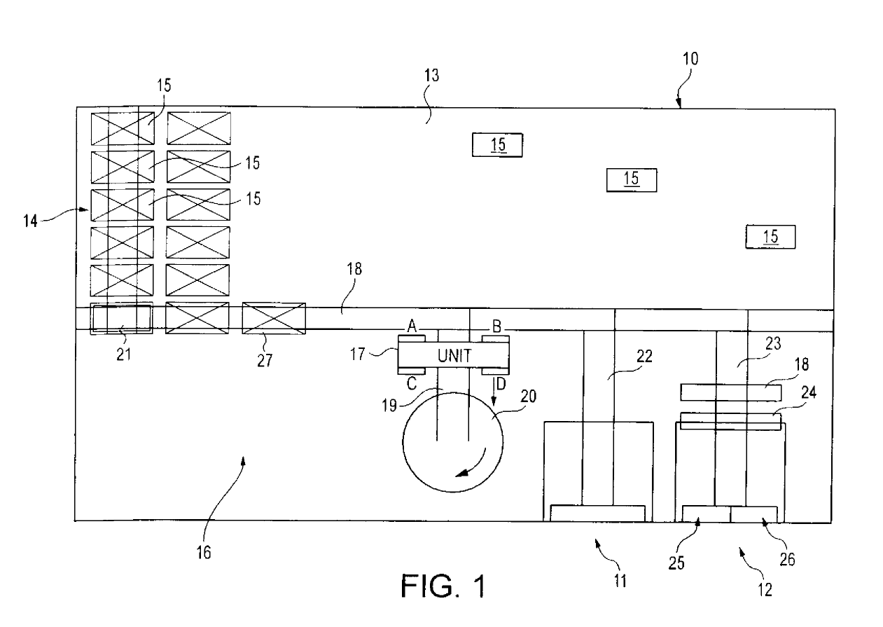

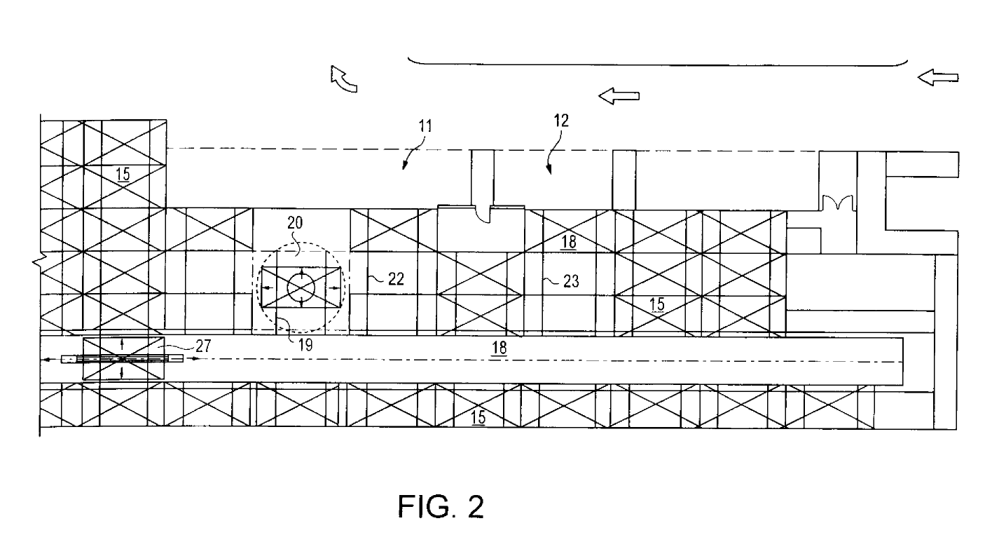

As illustrated in FIGS. 1 and 2, the overall facility 10 as shown from above in a block floor plan view, includes for example to access ports 11 and 12 at the front of the facility and storage area 13 at the rear of the facility. Exemplary storage locations 14 are shown at the left side of FIG. 1. Illustrated in rear storage locations are additional storage units 15. Units 15 can be stored throughout the facility in similar rows as those illustrated in area 14. Not all locations for storage units are illustrated but are understood. The left side of the front of the facility 16 can also be used for storage or for additional access areas such as areas 11 and 12.

In the exemplary layout illustrated in FIG. 1 and/or FIG. 2, storage unit 17 is shown being moved by the facility system. Storage unit 17 has been moved from main railway 18 to the rotation unit railway 19 so that the unit can be moved onto rotating platform 20 to change the orientation of unit 17 if desired. As illustrated, unit 17 has for access ports labeled A, B, C and D. Storage unit 17 can be rotated to any orientation so as to make the selected one of the access ports available to the user at a loading area. For example, if the user at loading area 12 has been assigned portion C of storage unit 17, the storage unit will be rotated on turntable 20 so that when the unit 17 is returned from main railway 18, access port C will be in proper position to be presented to the loading area door 25.

Before access unit 17 can be placed on railway 18, it has to be retrieved from its storage location by crane 21. Crane 21 loads the desired unit onto railway 18. The unit is then moved along railway 18, by trolley 27, until it reaches the desired junction railway. The selection of the desired junction railway is based upon the a destination of the storage unit. If the storage unit must first be rotated, then it will switch off to railway 19. If the unit does not need rotation for proper orientation, it may traveled down to railway 22 or 23. The selected railway will again depend on the access loading area selected by the user. Once a storage unit is traveling down the access rails to the loading area, as illustrated by exemplary unit 18, the rear door 24 will open to allow unit 18 to enter loading area 12. Once unit 18 is in loading area 12, front door 25 or 26 will open depending upon the access port available to the user at loading area 12. The size of doors and 25 and 26 are designed to allow access to only one access port of storage unit 18. There's also a very close fit between storage unit 18 and the frame of doors 25 and 26 to prevent access to the interior of loading area 12. If the user has access to a full side of unit 18 such as access to ports C and D or the user has access to the entire storage unit 18, then both doors 25 and 26 may be opened for the user.

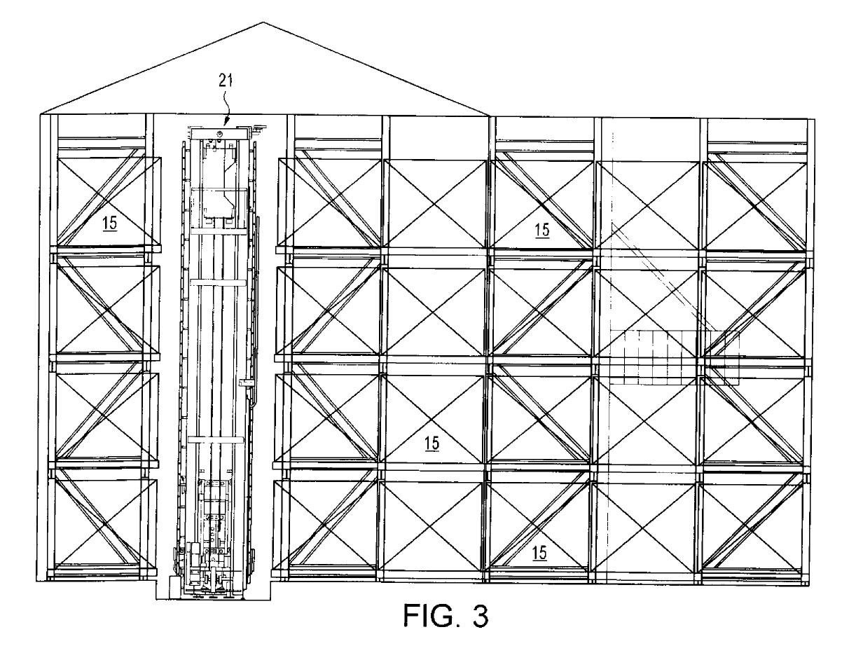

As illustrated in FIG. 3, the storage facility can have several levels. In the exemplary embodiment of FIG. 3, the storage facility is four levels high. Each of the four levels is used for storage of storage units 15. A crane 21, as illustrated in FIG. 1, is used to stack and retrieve a storage units 15 from the different levels, and to place the storage units onto the railway trolley 27, illustrated in FIGS. 1 and 2. The crane 21 is run by the system to reach down the rows and remove storage units 15 one at a time until the crane reaches far enough back in the stack to remove the desired unit. Crane 21 will re-store the undesired units in locations in the stack. The locations of the repositions undesired units will be maintained by the system. In this manner, units which had been moved inward to access a desired unit can be located at a later time.

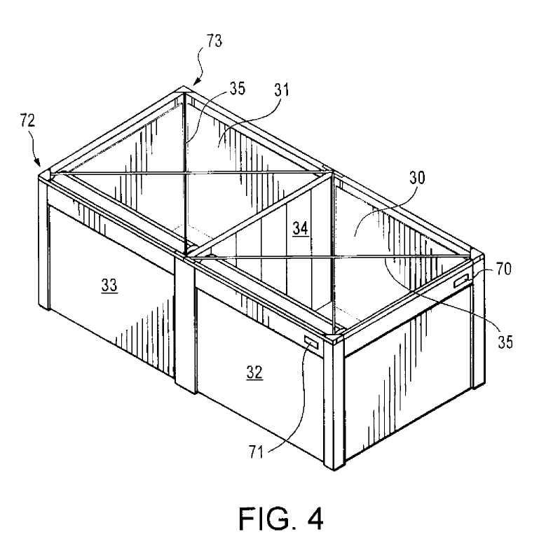

FIGS. 4, 5 and 6 provide more detailed perspective views of an exemplary one of the storage units 15. FIG. 4 illustrates a storage unit which has been divided into two separate compartments 30 and 31. Each of these compartments is provided with a roll up door 32 and 33. A wall 34 with in the unit separates compartments 30 and 31. All of the units of the storage system of the present invention have an open top with cross bracing 35 as illustrated. The open top is important for fire suppression issues. Each of the remaining sides and ends of the unit are solid walls. The unit is also constructed with a solid floor having a taper for the collection of spills within the unit.

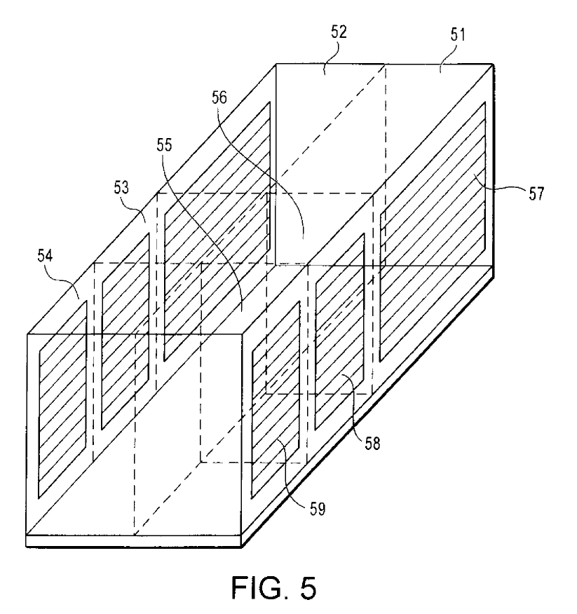

FIG. 5 illustrates a storage unit which has been divided into six compartments 51, 52, 53, 54, 55 and 56. Each of the compartments is provided with its own door such as door 57, 58 and 59. Storage compartments 51 and 52 are considered quarter size compartments while compartments 53, 54, 55 and 56 are one eighth size compartments. As described above, the storage unit illustrated and FIG. 5, can be rotated to the proper orientation to allow access to individual compartments of the storage unit. Because the storage unit of FIG. 5 has three doors on each side, the loading area illustrated in FIGS. 1 and 2 would need to be provisioned with three doors, one door being half the length of a storage unit to correspond to door 57 and the other doors being one quarter length to correspond to doors 58 and 59. It is not necessary to provide each loading area with three doors, the system can be set up so that a three door unit may only be excessive goal from certain loading areas.

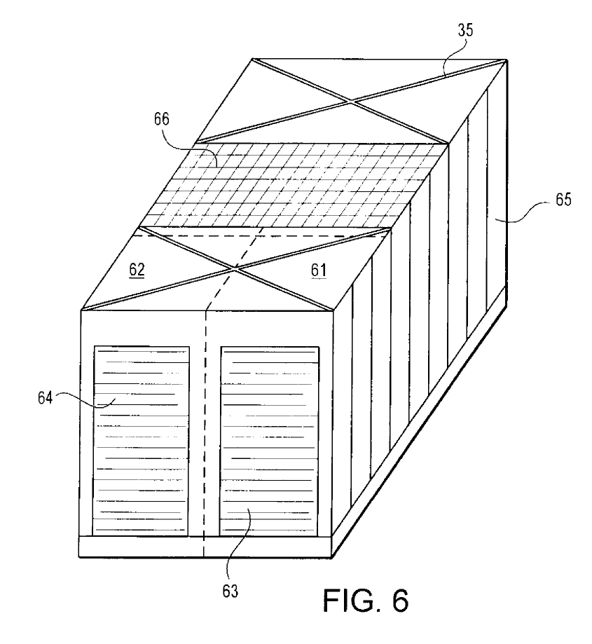

FIG. 6 illustrates another embodiment for a storage unit. This storage unit includes compartments 61 and 62 which are accessed from the end of the unit. The compartments are provided with doors 63 and 64. The storage unit illustrated in FIG. 6 can also be rotated by turntable 20 to allow access to the units 61 and 62 through doors 63 and 64. Again it may be necessary to provide a loading area with doors which correspond to the doors 63 and 64. However, a the overall dimensions of the standard size storage unit can be made such that a access to doors 63 and 64 can be accommodated through a standardized loading area.

FIG. 6 also illustrates the cross-bracing 35 as well as the solid walls 65. The wire mesh security screen 66 on the top of each storage unit is also illustrated in FIG. 6. This wire mesh prevents on authorized access to the storage unit that allows the storage unit to be open for fire suppression needs.

In addition, each storage unit, such as the unit illustrated and FIG. 4, will include a number of identity tags at locations around the unit, so that not only the unit but also the orientation of the unit can be determined and tracked by the system. For example, an exemplary embodiment of tag placement is illustrated in FIG. 4. A first tag 70 is placed on one end of the storage unit near a corner. A second tag 71 can be placed on one side of the unit year another corner. A third tag 72 may be placed at yet another corner of the unit, with a fourth tag 73 placed near the fourth corner. Because each of these tags is coded differently, the system by detecting the location of each tag can determine the orientation of the unit when it is in storage and when it is moving through the facility. It is possible to determine and track the orientation and movement of each unit with a single tag, however additional tag detection devices need to be deployed because the pending up on the orientation of the storage unit different sides of the unit passed by different portions of the facility. By placing tags on each of the four sides of the unit, fewer detection devices need to be deployed as one side of the unit will always pass by the detection device location.

In addition to tracking the orientation for proper orientation of the unit to a user, tracking the orientation of the unit can help to identify and control the loading of the unit for proper balancing of stacking. The system of the present intention in one exemplary embodiment deploys multiple tag readers in storage locations and along each of the railway tracks. Multiple readers provides for location confirmation redundancy and failsafe measures in the event of reader failure.

When the system is performing routine maintenance, it can update the positions of different units in storage.

The system not only tracks the orientation and location of units in real time for moving the units, but also stores this information for later use. By storing location and movement information about the individual units, the system can maintain a history of unit movement and user access. The system can learn from this information and develop parameters for more efficient storage of units based upon unit movement and orientation history and the present information of unit locations. For example, the system can determine the most frequently accessed units and the most recent users. The system can use such information to place storage units in locations which makes sense relative to the frequency of access of those units. For example most frequently or most recently accessed units can be placed on the outside locations near the central track 18 while less frequently used units a may be stored farther back in the stacks. Alternatively, more recently accessed units may be stored farther back as they are less likely to be used again, dependent upon overall averages and/or the specific history for that particular unit. However, because the system has the capacity to learn, it may make decisions different from the examples herein provided.

The control system of the present invention will learn many things about the storage and access habits of the average user. For example, frequency of access is typically greatest soon after a storage unit is first rented. Frequency of access quickly decreases after a first period of time. The system will learn the typical frequency of access and the typical decay curve for the typical user for the geographic location of the storage facility and the demographics of the users of the facility. The system will then use this information to make more efficient storage of units.

The facility is provided with fire safety and suppression systems. These systems include fire doors which are also sealed insulated doors so that the interior of the facility can be climate controlled which helps in the long term storage of items. The facility also has a sprinkler system which, when a fire is detected in a unit can localize fire suppression to that storage unit or to the compartment within the storage unit in which the fire is detected. As described above an illustrated, each of the storage units has an open top with a wire mesh to allow for fire suppression within the unit.

In addition to the sensors and detectors described above, the system also incorporates a series of movement and/or orientation detectors to detect any swaying in the system. If a storage unit contains items which may shift during transport to the facility, the shifting can cause swaying and or imbalance in the unit. In addition to the balance sensors mentioned above inertial or momentum sensors are incorporated to detect swaying from moving loads. In addition, liquids stored in units can cause swaying during movement of the units and can continue to sway after a unit is placed in a storage location. It is important to include sway sensors in an exemplary embodiment of the present intention in order to control these factors. Sway must be maintained within certain parameters to ensure the integrity of the system.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. An automated self-storage system comprising:
a storage facility having a series of storage container units in a series of storage bays of a frame system;
a facility access point;
a loading area;
a control access system;
a facility management system;
a central control system; and
a container unit handling system, wherein access doors form part of the boundary of the loading area.

2. The system of claim 1, wherein a computer tracking system and a location tracking system integrated with the central control system and facility management system, track the location of the units throughout the storage facility, wherein the computer tracking system maintains information regarding the location of the storage units for use by the location tracking system.

3. The system of claim 2, wherein the location tracking system comprises barcodes, scan tags, passive transponders, infrared tags, and radio frequency tags.

4. The system of claim 3, wherein the location tracking system communicates the location of each storage unit to the container handling device to retrieve and move the units via the facility management system.

5. The system of claim 4 wherein the facility management system is continuously updating information such as payments, frequency of visits, and habits of a user.

6. The system of claim 5, wherein information in the facility management system is processed by the central control system and sent to a management control system to manage the positions of all the units in the facility.

7. The system of claim 1, wherein the handling device includes a crane which travels from end to end on the rail way to retrieves units from any bay position in the facility, wherein the crane is automated and controlled by the management control system.

8. The system of claim 7, wherein a trolley on the rail way moves the storage unit obtained via the crane of the handling device in multiple directions on the rail way throughout the facility to present the units at the facility access doors.

9. The system of claim 8, wherein each bay in the frame system has rails which support a table which supports the storage unit, wherein the top of the table will have a slight indentation sloping towards a plurality of mid-points.

10. The system of claim 9, wherein a turn-table is accessible from the rail way to rotate the unit for proper display of a loading door of the storage unit in a loading area.

11. The system of claim 1, wherein scan readers are located in several locations within the facility to keep track of the units as they move through the facility.

12. The system of claim 1, wherein the management control system controls access to the unit, storage history for maintenance, and positioning for placement in the frame system, average time needed once the unit is displayed for loading or unloading, and weight limits in place for the size of the unit.

13. The system of claim 1, wherein the loading area is completely isolated from a main storage system of the facility.

14. The system of claim 1, wherein the access doors comprise a front door for access by the users to the loading area of the facility and a rear door which opens to the storage area of the facility, wherein the front door and the rear door are not in the open position simultaneously.
